(19) United States
(12) Patent Application Publication
(10) Pub. No.: US 2008/0175261 A1
(43) Pub. Date: Jul. 24, 2008

(54) Voice-controlled media adaptor apparatus

(75) Inventor: Michael Wang, Tao Yuan Shien (TW)

Correspondence Address: Reed Smith LLP, Suite 1400, 3110 Fairview Park Drive, Falls Church, VA, 22042, US

(73) Assignee: Quanta Computer, Inc.

(21) Appl. No.: 11/808,739

(22) Filed: Jun. 12, 2007

(30) Foreign Application Priority Data
Jan. 24, 2007 (TW) 096102608

(51) Int. Cl. H04L 12/56

(52) U.S. Cl. 370/420

(57) ABSTRACT

The invention provides a voice-controlled media adaptor apparatus for an electronic appliance, especially for a conventional electronic appliance. The electronic appliance includes an input port. The media adaptor apparatus according to the invention is capable of receiving a media information, processing the received media information, and directing the processed media information to an output port thereof mating the input port of the electronic appliance. The media adaptor apparatus according to the invention is also capable of receiving a voice command, converting the received voice command into a command information, and selectively directing the command information to a communication interface thereof.

### BACKGROUND OF THE INVENTION

1. Field of the Invention

The invention relates to a voice-controlled media adaptor apparatus and a voice-controlled adaptor assembly for an electronic appliance, and particularly applicable for the conventional electronic appliances using infrared remote control technologies.

2. Description of the Prior Art

A lot of large IT companies and companies of home electrical appliance are actively developing applications relative to a digital family. The core spirit of a digital family is to connect all the information, communication, and consumer electrical appliances at home to form a home networking structure via wired or wireless network technologies. And a home networking can be integrated with external networks via specific home gateways, so as to implement aspirations of the intelligent life, such as home energy management, home security, home care, remote maintenance for electrical appliances, and digital reactive television.

The novel digital home appliance is coming to the market. For example, the novel digital home appliance referred herein can be the video/audio product with internet function such as a digital set-top box, a movable media player, a DVD player, a video/audio digital media center, a videogame, or an MP3 player. A user can obtain the digital media anywhere in the house including living rooms, kitchens, and bedrooms via these digital home appliances.

However, most (or all) current home electronic appliances are conventional electronic appliances without digital home technology. Thus, the only way to integrate the conventional video/audio appliance (e.g., television or stereo appliance) in the region of a digital home is utilizing a media adaptor.

Thus, in order to permit a user conveniently operating a media adaptor mated with the conventional video/audio appliance, a scope of the invention is to provide a voice-controlled adaptor apparatus and a voice-controlled adaptor assembly with a separated voice-controlled unit and a media adaptor.

Besides, most of the conventional home electrical appliances are equipped with infrared remote technologies. When a user operates the conventional home electrical appliance connected to a voice-controlled adaptor apparatus, the voice-controlled adaptor apparatus and the conventional home electrical appliance must be operated separately. Obviously, the above mentioned operation way is very inconvenient for the user.

Accordingly, another scope of the invention is to provide a centralized-controlled voice-controlled media adaptor apparatus and voice-controlled adaptor assembly. In this way, users can use voice commands as inputs to easily operate or manage the voice-controlled media adaptor apparatus (or the voice-controlled adaptor assembly), the home electrical appliance connected to the voice-controlled media adaptor apparatus, and even the home electrical appliance adjacent to the voice-controlled media adaptor apparatus.

### SUMMARY OF THE INVENTION

A voice-controlled media adaptor apparatus of the first preferred embodiment according to the invention is applied for an electronic appliance. The electronic appliance includes an input port. The voice-controlled media adaptor apparatus of the first preferred embodiment according to the invention includes a communication interface, an output port, a voice receiving module, a voice recognizing module, and a processing module. The communication interface is configured to receive media information with a transmission protocol. The output port operatively mates with the input port of the electronic appliance. The voice receiving module is configured to receive a voice command. The voice recognizing module is electrically connected to the voice receiving module. The voice recognizing module is used for receiving the voice command received by the voice receiving module, and converting the received voice command into a command information. The processing module is electrically connected to the communication interface, the output port and the voice recognizing module, respectively. The processing module is used for processing the received media information, directing the processed media information to the output port, and selectively directing the command information to the communication interface.

The voice-controlled media adaptor apparatus of the first preferred embodiment according to the invention can further include a radiation-based signal transmitter. And the electronic appliance can include a radiation-based signal receiver. The radiation-based signal transmitter is electrically connected to the processing module and disposed so as to have a radiation cover zone covering the radiation-based signal receiver. The processing module also selectively drives the radiation-based signal transmitter to emit a radiation beam which is representative of the command information.

A voice-controlled media adaptor assembly of the second preferred embodiment according to the invention is applied for an electronic appliance. The electronic appliance includes an input port. The voice-controlled media adaptor assembly of the second preferred embodiment according to the invention includes a voice-controlled remote controller and a media adaptor. The voice-controlled remote controller comprises a voice receiving module, a voice recognizing module, and a transmitting module. The voice receiving module is configured to receive a voice command. The voice recognizing module is electrically connected to the voice receiving module. The voice recognizing module is used for receiving the voice command received by the voice receiving module and converting the received voice command into command information. And, the transmitting module is electrically connected to the voice recognizing module. The transmitting module is used for receiving the command information and transmitting the command information with a first transmission protocol. The media adaptor comprises a receiving module, a communication interface, an output port, and a processing module. The receiving module is configured to receive the command information with the first transmission protocol. The communication interface is configured to receive media information with a second transmission protocol. The output port operatively mates with the input port of the electronic appliance. The processing module is electrically connected to the receiving module, the communication interface and the output port, respectively. The processing module is used for processing the received media information, directing the processed media information to the output port, receiving the command information received by the receiving module, and selectively directing the command information received by the receiving module to the communication interface.

The voice-controlled media adaptor assembly of the second preferred embodiment according to the invention can further include a radiation-based signal transmitter. And the electronic appliance can include a radiation-based signal receiver. The radiation-based signal transmitter is electrically connected to the processing module and disposed so as to have a radiation cover zone covering the radiation-based signal receiver. The processing module also selectively drives the radiation-based signal transmitter to emit a radiation beam which is representative of the command information.

The advantage and spirit of the invention may be understood by the following recitations together with the appended drawings.

### BRIEF DESCRIPTION OF THE APPENDED DRAWINGS

FIG. 1A is an external view diagram of voice-controlled media adaptor apparatus 1 in the first preferred embodiment according to the invention and an electronic appliance 3.

FIG. 1B is a functional block diagram of some necessary elements of voice-controlled media adaptor apparatus 1 in a preferred embodiment according to the invention.

FIG. 2A is an external view diagram of voice-controlled media adaptor assembly 4 in a preferred embodiment according to the invention and an electronic appliance 5.

FIG. 2B is a functional block diagram of some necessary elements of voice-controlled media adaptor assembly 4 in a preferred embodiment according to the invention.

### DETAILED DESCRIPTION OF THE INVENTION

The invention provides a voice-controlled media adaptor apparatus and a voice-controlled adaptor assembly. Users are permitted to use voice commands as inputs to operate the media adaptor apparatus (or the media adaptor) to process media information and to transmit the media information to a conventional video/audio appliance. Further, users can use voice commands as inputs to easily operate or manage the voice-controlled media adaptor apparatus (or the voice-controlled adaptor assembly) provided by the invention, the home electrical appliances connected to the voice-controlled media adaptor apparatus, and even the home electrical appliances adjacent to the voice-controlled media adaptor apparatus. The feature, spirit, advantage, and practical easiness of the present invention will be described in detail by the following preferred embodiments.

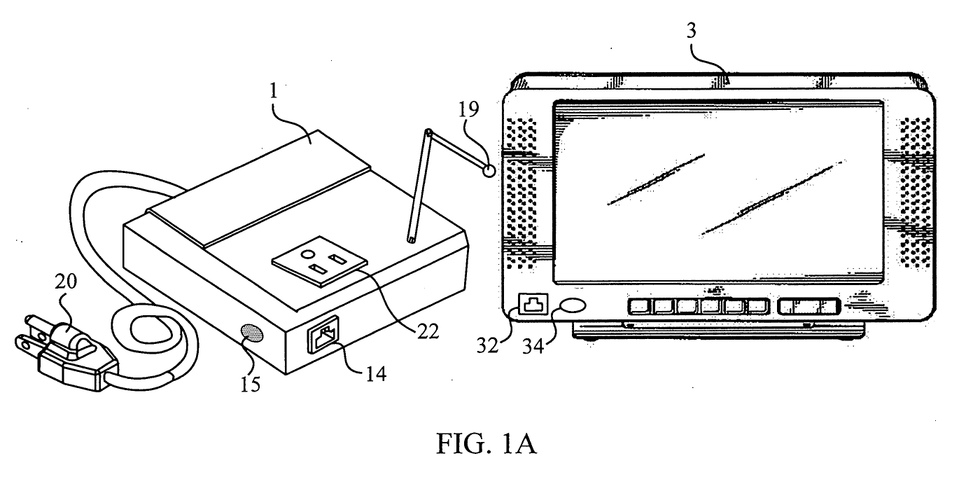

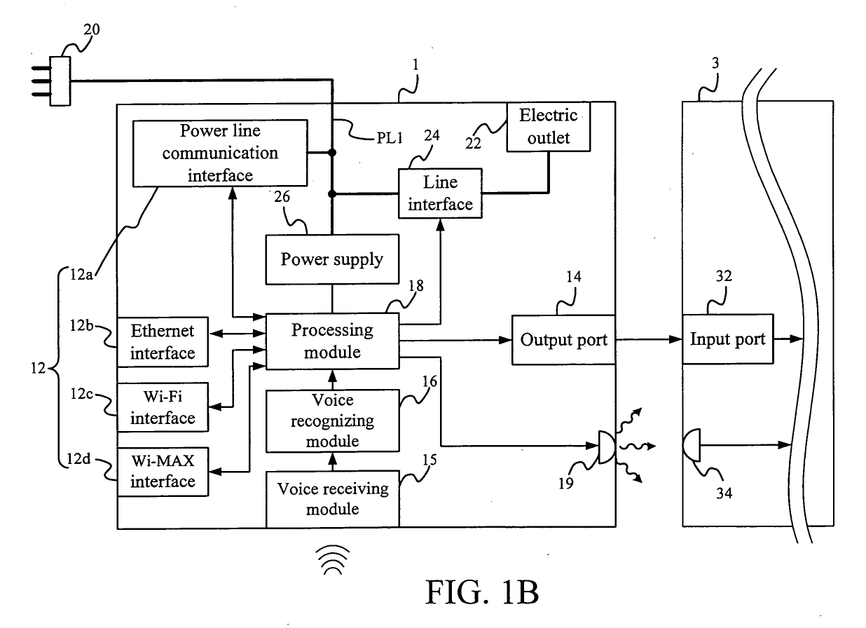

Referring to FIG. 1A and FIG. 1B, the first preferred embodiment according to the invention is illustrated. FIG. 1A is an external view diagram of a voice-controlled media adaptor apparatus 1 in this embodiment. And FIG. 1A also illustrates an electronic appliance 3 connected to the home networking structure via voice-controlled media adaptor apparatus 1. FIG. 1B illustrates some necessary functional blocks of voice-controlled media adaptor apparatus 1.

As shown in FIG. 1A, voice-controlled media adaptor apparatus 1 is applicable for electronic appliance 3, for example, a conventional television, a conventional stereo appliance. And, electronic appliance 3 includes an input port 32. Taking a conventional television as an example of electronic appliance 3, input port 32 of electronic appliance 3 is the video/audio input terminal of the conventional television.

As shown in FIG. 1B, voice-controlled media adaptor apparatus 1 in this embodiment includes a communication interface 12, an output port 14, a voice receiving module 15, a voice recognizing module 16, and a processing module 18.

Communication interface 12 is configured to receive media information with a transmission protocol. And, output port 14 operatively mates with input port 32 of electronic appliance 3. That is to say, users can use a cable to connect input port 32 of electronic appliance 3 and output port 14 of voice-controlled media adaptor apparatus 1.

Electronic appliance 3 connected to a home gateway of home networking structure via voice-controlled media adaptor apparatus 1 can enter the region of a digital family. The transmission form between voice-controlled media adaptor apparatus 1 and the home gateway can be wired or wireless. Thus, in an embodiment, communication interface 12 can be a communication interface conforming to existing wired communication protocols, such as a power line communication interface 12a conforming to a power line communication protocol or an Ethernet interface 12b conforming to an Ethernet protocol. Communication interface 12 can also be a communication interface conforming to existing wireless communication protocols, such as a Wi-Fi interface 12c conforming to a Wi-Fi protocol or a WiMax interface 12d conforming to a WiMax protocol. In practical applications, voice-controlled media adaptor apparatus 1 can be equipped by various communication interfaces, as shown in FIG. 1B.

Voice receiving module 15 is configured to receive a voice command. In an embodiment, voice receiving module 15 is a microphone.

Voice recognizing module 16 is electrically connected to voice receiving module 15. And, voice recognizing module 16 is used for receiving the voice command received by voice receiving module 15 and converting the received voice command into command information.

Processing module 18 is electrically connected to communication interface 12, output port 14, and voice recognizing module 16, respectively. And processing module 18 is used for processing the received media information, directing the processed media information to output port 14, and selectively directing the command information to communication interface 12.

In general, electronic appliance 3 also includes a radiation-based signal receiver 34. In an embodiment, also shown in FIG. 1A and FIG. 1B, voice-controlled media adaptor apparatus 1 further includes a radiation-based signal transmitter 19. And, radiation-based signal transmitter 19 is electrically connected to processing module 18 and disposed so as to have a radiation cover zone covering a radiation-based signal receiver 34. Processing module 18 also selectively drives radiation-based signal transmitter 19 to emit a radiation beam which is representative of the command information. And, electronic appliance 3 receives the radiation beam by radiation-based signal receiver 34, converts the radiation signal into a command information, and then functions according to the command information. In this way, users can use voice commands as inputs to easily operate or manage voice-controlled media adaptor apparatus 1, the electronic appliance 3 connected to voice-controlled media adaptor apparatus 1, and even the home electrical appliances adjacent to voice-controlled media adaptor apparatus 1 or the home electrical appliances in the radiation cover zone of radiation-based signal transmitter 19.

As conventional electronic appliances, radiation-based signal receiver 34 can be equipped on the front panel of electronic appliance 3. Thus, as shown in FIG. 1A, radiation-based signal transmitter 19 is quipped on a flexible component, so that users can easily adjust the radiation cover zone of radiation-based signal transmitter 19.

In an embodiment, radiation-based signal receiver 34 is an infrared receiver, radiation-based signal transmitter 19 is an infrared transmitter, and the radiation beam is an infrared beam.

As also shown in FIG. 1A and FIG. 1B, in another preferred embodiment, voice-controlled media adaptor apparatus 1 further includes an electric plug 20, an electric outlet 22, a line interface 24, and a power supply 26. Electric plug 20 is adapted to be connected to an external power (not shown in the diagram). And, electric outlet 22 is electrically connected to electric plug 20 via a power line PL1. Line interface 24 is electrically connected in series to power line PL1. And line interface 24 is capable of being controlled to cut off or provide transmission of a first electric power over power line PL1. Power supply 26 is coupled to electric line PL1 and electrically connected to processing module 18. And, power supply 26 is used for converting the first electric power into a second power and supplying the second electric power to processing module 18.

Particularly, processing module 18 selectively controls line interface 24 to cut off or provide the transmission of the first electric power over power line PL1 in response to the command information. By doing so, even electronic appliance 3 does not have abilities of infrared remote communication, users can still plug the electric plug of electronic appliance 3 into electric outlet 22 of voice-controlled media adaptor apparatus 1, so as to control electronic appliance 3 with voice by voice-controlled media adaptor apparatus 1.

In an embodiment, the line interface is a traic or a relay.

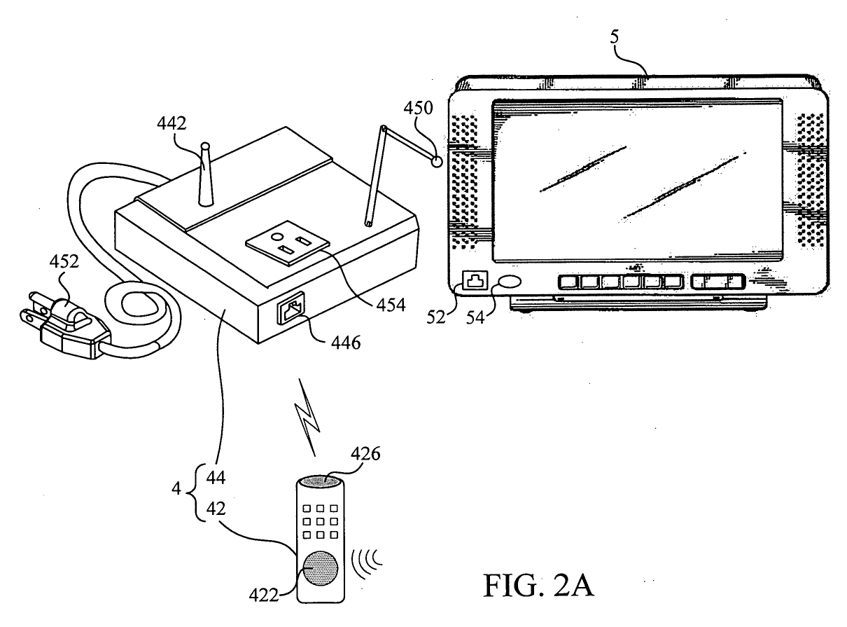

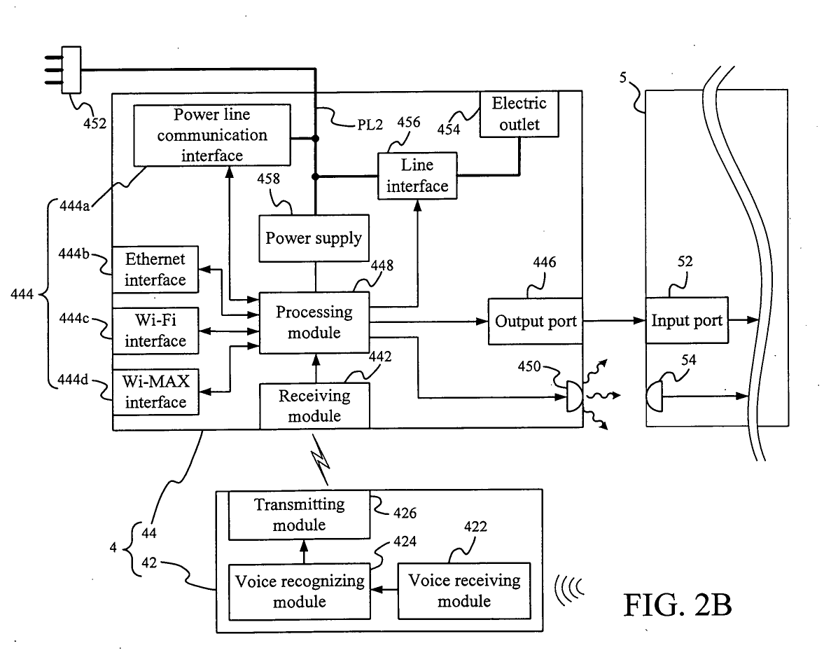

According to the invention, the voice-controlled unit and the media adaptor can also be separated. Referring to FIG. 2A and FIG. 2B, the second preferred embodiment according to the invention is illustrated. FIG. 2A is an external view diagram of a voice-controlled media adaptor assembly 4 in this embodiment. And FIG. 2A also illustrates an electronic appliance 5 connected to the home networking structure by voice-controlled media adaptor assembly 4. FIG. 2B illustrates some necessary functional blocks of voice-controlled media adaptor assembly 4.

As shown in FIG. 2A, voice-controlled media adaptor assembly 4 is applicable for electronic appliance 5, for example, a conventional television or a conventional stereo appliance. And, electronic appliance 5 includes an input port 52. Taking a conventional television as an example of electronic appliance 5, input port 52 of electronic appliance 5 is a video/audio input terminal of the conventional television.

As shown in FIG. 2A, voice-controlled media adaptor assembly 4 in this embodiment includes a voice-controlled remote controller 42 and a media adaptor 44.

As shown in FIG. 2B, voice-controlled remote controller 42 includes a voice receiving module 422, a voice recognizing module 424, and a transmitting module 426. Voice receiving module 422 is configured to receive a voice command. In an embodiment, voice receiving module 422 is a microphone.

Voice recognizing module 424 is electrically connected to voice receiving module 422. And, voice recognizing module 424 is used for receiving the voice command received by voice receiving module 422 and converting the received voice command into command information.

Transmitting module 426 is electrically connected to voice recognizing module 424. And, transmitting module 426 is used for receiving the command information and transmitting the command information with a first transmission protocol.

In an embodiment, the first transmission protocol can be a wireless transmission protocol, such as a Wi-Fi protocol, a WiMax protocol, IEEE 802.11-based protocols, or a Bluetooth protocol.

As also shown in FIG. 2B, media adaptor 44 includes a receiving module 442, a communication interface 444, an output port 446, and a processing module 448.

Receiving module 442 is configured to receive the command information with the first transmission protocol. And, communication interface 444 is configured to receive media information with a second transmission protocol. Output port 446 operatively mates with input port 52 of electronic appliance 5. That is to say, a user can use a cable to connect input port 52 of electronic appliance 5 and output port 446 of media adaptor 44.

Electronic appliance 5 connected to a home gateway of home networking structure via media adaptor 44 can enter the region of a digital family. The transmission form between media adaptor 44 and the home gateway can be wired or wireless. Thus, in an embodiment, communication interface 444 can be a communication interface conforming to existing wired communication protocol applicable to family, such as a power line communication interface 444a conforming to a power line communication protocol or an Ethernet interface 444b conforming to an Ethernet protocol. Communication interface 444 can also be a communication interface conforming to existing wireless communication protocols, such as a Wi-Fi interface 444c conforming to a Wi-Fi protocol or a WiMax interface 444d conforming to a WiMax protocol. In practical applications, media adaptor 44 can be equipped by various communication interfaces, as shown in FIG. 2B.

Processing module 448 is electrically connected to receiving module 442, communication interface 444 and output port 446, respectively. And, processing module 448 is used for processing the received media information, directing the processed media information to output port 446, and selectively directing the command information received by receiving module 442 to communication interface 444.

As shown in FIG. 2A, voice-controlled remote controller 42 is performed as a hand-held device. Obviously, voice-controlled remote controller 42, not limited in the form of a hand-held device, can be also performed as a desktop device, a hanging device, or a grounded device. Voice-controlled remote controller 42 can even be embedded into a home gateway or a communication device within a home networking structure. In this condition, receiving module 442 and communication interface 444 can be combined into a component.

In general, electronic appliance 5 also includes a radiation-based signal receiver 54. In a preferred embodiment according to the invention, also shown in FIG. 2A and FIG. 2B, media adaptor 44 further includes a radiation-based signal transmitter 450. And, radiation-based signal transmitter 450 is electrically connected to processing module 448 and disposed so as to have a radiation cover zone covering radiation-based signal receiver 54. Processing module 448 also selectively drives radiation-based signal transmitter 450 to emit a radiation beam which is representative of the command information. And, electronic appliance 5 receives the radiation beam by radiation-based signal receiver 54, converts the radiation signal into a command information, and then functions according to the command information. In this way, users can use voice commands as inputs to easily operate or manage media adaptor 44, electronic appliance 5 connected to media adaptor 44, and even the home electrical appliance adjacent to media adaptor 44 or the home electrical appliance in the radiation cover zone of radiation-based signal transmitter 450.

As conventional electronic appliances, radiation-based signal receiver 54 can be equipped on the front panel of electronic appliance 5. Thus, as shown in FIG. 2A, radiation-based signal transmitter 450 is quipped on a flexible component, so that users can easily adjust the radiation cover zone of radiation-based signal transmitter 450.

In an embodiment, radiation-based signal receiver 54 is an infrared receiver, radiation-based signal transmitter 450 is an infrared transmitter, and the radiation beam is an infrared beam.

As also shown in FIG. 2A and FIG. 2B, in another preferred embodiment, media adaptor 44 further includes an electric plug 452, an electric outlet 454, a line interface 456, and a power supply 458. Electric plug 452 is adapted to be connected to an external power (not shown in the diagram). And, electric outlet 454 is electrically connected to electric plug 452 via a power line PL2. Line interface 456 is electrically connected in series to power line PL2. And line interface 456 is capable of being controlled to cut off or provide transmission of a first electric power over power line PL2. Power supply 458 is coupled to line interface 456 and electrically connected to processing module 448. And, power supply 458 is used for converting the first electric power into a second power and supplying the second electric power to processing module 448.

Particularly, processing module 448 selectively controls line interface 456 to cut off or provide the transmission of the first electric power over power line PL2 in response to the command information. By doing so, even electronic appliance 5 does not have abilities of infrared remote communication, users can still plug the electric plug of electronic appliance 5 into electric outlet 454 of media adaptor 44, so as to control electronic appliance 5 with voice by media adaptor assembly 4.

In an embodiment, the line interface 456 is a traic or a relay.

With above descriptions about the preferred embodiment, it is clearly known that the voice-controlled media adaptor apparatus and the voice-controlled adaptor assembly according to the invention permit users using voice commands as inputs to easily operate or manage the voice-controlled media adaptor apparatus (or the voice-controlled adaptor assembly), the home electrical appliance connected to the voice-controlled media adaptor apparatus, and even the home electrical appliance adjacent to the voice-controlled media adaptor apparatus, especially conventional household appliances.

In addition, it should be noted that the applications of the voice-controlled media adaptor apparatus and the voice-controlled adaptor assembly according to the invention are not limited in families; they are also applicable for the place where most current electronic appliances are conventional electronic appliances, such as classrooms, offices, factories, and places for exhibition.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A voice-controlled media adaptor apparatus for an electronic appliance comprising an input port, the media adaptor apparatus comprising:
a communication interface configured to receive a media information with a transmission protocol;
an output port, operatively mating with the input port of the electronic appliance;
a voice receiving module configured to receive a voice command;
a voice recognizing module, electrically connected to the voice receiving module, for receiving the voice command received by the voice receiving module and converting the received voice command into a command information; and
a processing module, electrically connected to the communication interface, the output port, and the voice recognizing module, respectively, for processing the received media information, directing the processed media information to the output port, and selectively directing the command information to the communication interface.

2. The voice-controlled media adaptor apparatus of claim 1, wherein the electronic appliance also comprises a radiation-based signal receiver, the voice-controlled media adaptor apparatus further comprising:
a radiation-based signal transmitter electrically connected to the processing module and disposed so as to have a radiation cover zone covering the radiation-based signal receiver, the processing module also selectively driving the radiation-based signal transmitter to emit a radiation beam representative of the command information.

3. The voice-controlled media adaptor apparatus of claim 2, wherein the radiation-based signal receiver is an infrared receiver, the radiation-based signal transmitter is an infrared transmitter, and the radiation beam is an infrared beam.

4. The voice-controlled media adaptor apparatus of claim 1, wherein the transmission protocol is one selected from the group consisting of: a power line communication protocol, an Ethernet protocol, a Wi-Fi protocol, and a WiMax protocol.

5. The voice-controlled media adaptor apparatus of claim 1, further comprising:
an electric plug adapted to be connected to an external power;
an electric outlet, electrically connected to the electric plug via a power line;
a line interface, electrically connected in series to the power line, capable of being controlled to cut off or provide transmission of a first electric power over the power line; and
a power supply, coupled to the power line and electrically connected to the processing module, for converting the first electric power into a second electric power and supplying the second electric power to the processing module;
wherein the processing module selectively controls the line interface to cut off or provide the transmission of the first electric power over the power line in response to the command information.

6. The voice-controlled media adaptor apparatus of claim 5, wherein the line interface is a traic or a relay.

7. The voice-controlled media adaptor apparatus of claim 1, wherein the voice receiving module is a microphone.

8. A voice-controlled media adaptor assembly for an electronic appliance comprising an input port, said media adaptor assembly comprising:
a voice-controlled remote controller, comprising:
a voice receiving module configured to receive a voice command;
a voice recognizing module, electrically connected to the voice receiving module, for receiving the voice command received by the voice receiving module and converting the received voice command into a command information; and
a transmitting module, electrically connected to the voice recognizing module, for receiving the command information and transmitting the command information with a first transmission protocol; and
a media adaptor, comprising:
a receiving module configured to receive the command information with the first transmission protocol;
a communication interface configured to receive a media information with a second transmission protocol;
an output port, operatively mating with the input port of the electronic appliance; and
a processing module, electrically connected to the receiving module, the communication interface, and the output port, respectively, for processing the received media information, directing the processed media information to the output port, and selectively directing the command information received by the receiving module to the communication interface.

9. The voice-controlled media adaptor assembly of claim 8, wherein the electronic appliance also comprises a radiation-based signal receiver, the media adaptor further comprises a radiation-based signal transmitter electrically connected to the processing module and disposed so as to have a radiation cover zone covering the radiation-based signal receiver, the processing module also selectively drives the radiation-based signal transmitter to emit a radiation beam representative of the command information.

10. The voice-controlled media adaptor assembly of claim 9, wherein the radiation-based signal receiver is an infrared receiver, the radiation-based signal transmitter is an infrared transmitter, and the radiation beam is an infrared beam.

11. The voice-controlled media adaptor assembly of claim 8, wherein the first transmission protocol is one selected from the group consisting of: a wireless protocol, a Wi-Fi protocol, a WiMax protocol, IEEE 802.11-based protocols, and a Bluetooth protocol.

12. The voice-controlled media adaptor assembly of claim 8, wherein the second transmission protocol is one selected from the group consisting of: a power line communication protocol, an Ethernet protocol, a Wi-Fi protocol, and a WiMax protocol.

13. The voice-controlled media adaptor assembly of claim 8, wherein the receiving module and the communication interface are the same.

14. The voice-controlled media adaptor assembly of claim 8, wherein said media adaptor further comprises:
an electric plug adapted to be connected to an external power;
an electric outlet, electrically connected to the electric plug via a power line;
a line interface, electrically connected in series to the power line, capable of being controlled to cut off or provide transmission of a first electric power over the power line; and
a power supply, coupled to the power line and electrically connected to the processing module, for converting the first electric power into a second electric power and supplying the second electric power to the processing module;
wherein the processing module selectively controls the line interface to cut off or provide the transmission of the first electric power over the power line in response to the command information.

15. The voice-controlled media adaptor assembly of claim 14, wherein the line interface is a traic or a relay.

16. The voice-controlled media adaptor assembly of claim 8, wherein the voice receiving module is a microphone.
